(19) United States
(12) Patent Application Publication
(10) Pub. No.: US 2016/0043394 A1
(43) Pub. Date: Feb. 11, 2016

(54) CATHODE SYNTHESIZED BY FLUX METHOD AND BATTERY COMPRISING SAME

(71) Applicant: E.I. DU PONT DE NEMOURS AND COMPANY, Wilmington, DE (US)

(72) Inventors: Jun J. Liu, Wilmington, DE (US); Mark Gerrit Roelofs, Earleville, MD (US); Carmine Torardi, Wilmington (US)

(21) Appl. No.: 14/776,332

(22) PCT Filed: Mar. 14, 2014
(86) PCT No.: PCT/US14/28174

§ 371 Date: Sep. 14, 2015

Related U.S. Application Data
(60) Provisional application No. 61/800,945, filed on Mar. 15, 2013.

(51) Int. Cl. H01M 4/505; C01G 53/00

(52) U.S. Cl. CPC H01M 4/505; C01G 53/54; H01M 2004/028

(57) ABSTRACT

The present invention is a method for the preparation of cathode active materials, a cathode comprising the cathode active materials, and a battery comprising same. The present method comprises the step of combining metal salts and or oxides with a flux agent, and heating the mixture to at least the melting temperature of the flux agent. Cathode active materials obtained by the process of this invention have larger average particle size than the same cathode materials obtained by co-precipitation, and a higher than expected rate capability.

### BACKGROUND

With the advancement in portable electronic devices and intense interest in plug-in hybrid electric vehicles, there is great demand to increase the energy and power capabilities of lithium ion batteries. In this regard, the 5 V spinel cathode LiMn₂₋ₓMₓO₄ (where M is e.g. Co, Cr, Ni, Fe, or Cu, and x is about 0.5) has drawn much attention due to its high operating voltage and the high intrinsic rate capability offered by the 3-dimensional lithium ion diffusion in the spinel lattice. Moreover, the difficulties encountered with the dissolution of manganese and Jahn-Teller distortion in the 4 V LiMn₂O₄ cathode are suppressed in LiMn₂₋ₓMₓO₄ as it contains less Mn³⁺ in the material. In this regard, a 5 V spinel cathode such as LiMn_{1.5}Ni_{0.5}O₄ is very attractive due to a nearly flat operating voltage close to 5 V and an acceptably high capacity arising from operation of the Ni^{2+/3+} and Ni^{3+m+} redox couples.

Solid-state synthesis is the most widely used method for synthesis of cathode materials for lithium ion batteries. However, substituted LiMn_{1.5-x}Ni_{0.5-y}M_{x+y}O₄, especially with a low quantity of M dopant, synthesized by traditional solid-state synthesis encounters the formation Li_{z}Ni_{1-z}O impurity which reduces the capacity and aggravates the loss of capacity during cycling. Additionally, solid-state synthesis products also suffer from inhomogeneity, uncontrollable particle growth and agglomeration.

Synthesis of high-quality substituted LiMn_{1.5-x}Ni_{0.5-y}M_{x+y}O₄ 5 V spinel cathode materials requires the uniform mixing of the metal precursors. Co-precipitation synthesis can realize the uniform mixture of transition metals at the nano-level through precipitating transition metal hydroxides in alkaline solution. However, co-precipitation synthesis involves complicated follow-up procedures, such as filtering, washing, and subsequent mixing with a lithium source. Solgel methods can overcome some disadvantages of conventional solid-state synthesis methods due to the high chemical homogeneity of the transition metals precursors, and sol-gel synthesis can also avoid additional mixing with lithium source. But sol-gel synthesis needs an additional chemical-chelating agent and includes an additional gel formation step. Additionally, the particle size of sol-gel product is small (normally <1 um), which significantly increases the surface area and accelerates the side reaction with the electrolyte.

### SUMMARY OF THE INVENTION

In one aspect the present invention is a method for preparing a cathode active composition of the formula Li_{z}Mn_{2-x-y}AₓQ_{y}O_{4-d} (Formula I), wherein the method comprises the steps of:
(a) combining
   (i) the salts and/or oxides of the metals Li, Mn, A and Q with
   (ii) a flux agent having a melting temperature in the range of from about 200° C. to about 850° C.,
to form a mixture of same;
(b) heating the mixture of step (a) to a temperature of at least the melting temperature of the flux agent, to obtain a molten flux composition comprising the salts and/or oxides of the metals Li, Mn, A and Q, and flux agent; and
(c) cooling the molten flux composition of step (b) at a cooling rate of less than about 20° C./minute for at least until the temperature is below about 650° C., or about 600° C., or about 550° C., or about 500° C.,
   wherein:
A is at least one metal selected from the group consisting of Ni, Co, Fe, Cr; Q is at least one metal selected from the group consisting of Li, Al, Cr, Ni, Fe, Ga, Zn, Ca, Co, Nb, Mo, Ti, Zr, Mg, V and Cu; x is any value in the range from 0.35 to less than 0.6; y is any value in the range of greater than 0.005 to about 0.12; d is any value in the range of from 0 to about 0.3; and z is any value in the range of greater than 0.9 to about 1.1.

### DETAILED DESCRIPTION OF THE INVENTION

Compositions of the present invention are obtained by a process comprising the step of combining salts or oxides of metals selected from the group consisting of Li, Mn, Ni, Co, Fe, Cr, Al, Ga, Zn, Ca, Nb, Mo, Ti, Zr, Mg, V and Cu. For example, lithium salts of organic or inorganic acid or oxyacid, or mixture thereof. In another embodiment compound (i) is a lithium halide, acetate, carbonate, oxyhalide, amide, hydroxide, azide, carbide, or hydride, or mixture thereof, or Li₂CO₃, LiNO₃, LiOH, or mixtures thereof are useful in the practice of the present invention. In one embodiment, none of the metal(s) selected for Q are the same as any of the metal(s) selected for A.

Manganese salts such as, for example, manganese salts of organic and inorganic acids and oxyacids, or oxides, or mixtures thereof are useful herein. In another embodiment manganese compounds suitable for the practice of the present invention can be selected from manganese oxide, carbonate, halide, hydroxide, sulfate, acetate, nitrate, sulfide or phosphate, or mixture thereof, or MnO₂, MnCO₃, Mn₂O₃, or mixtures thereof.

Metal compounds comprising Ni, Co, Fe, Cr, Li, Al, Ga, Zn Ca, Nb, Mo, Ti, Zr, Mg, and V are suitable for use in the process for preparing the cathode active materials described by Formula I.

In addition, the process of the present invention requires a flux agent. A flux agent includes those materials that, when heated according to the practice of the present invention, transform into a material that melts under the operating conditions of the present invention to provide a flux composition. The flux agent comprises, but is not limited to, halides, sulfates, nitrates, tungstates, vanadic-acid salts, molybdates, and niobates, borates, or compounds that can generate halide, sulfate, nitrate, tungstate, vanadic-acid salt, molybdate, niobate, or borate compounds during the heating process. The cations of the flux agent can be an alkali metal, or alkaline earth metal, or other cations which form a molten composition during the heating process.

In one embodiment the flux agent can be an alkali metal halide or sulfate, or mixtures thereof. In another embodiment the flux agent can be selected from a lithium halide or lithium sulfate, or mixtures thereof. In a particular embodiment the flux agent can be LiCl.

The metal salts and/or oxides as defined hereinabove can be mixed in any molar or weight ratio that is suitable for obtaining the composition of Formula I under the conditions of the process described herein. For example, the components can be mixed in any ratio whereby the sum of the moles of lithium and the moles of manganese and the moles of A and the moles of Q, relative to the moles of the flux agent is in the range of about 1:100 to about 100:1, to form a flux reaction mixture upon heating.

The mixture is heated until a temperature at least about the melting range of the flux agent (flux temperature) is obtained, and the temperature can be held at or above the flux temperature for a period of at least about 30 minutes, for up to about 72 hours. For example, the temperature of the mixture can be raised to at least about 200° C., or at least about 600° C., or at least about 850° C. to obtain a flux composition.

It is desirable that the flux composition be cooled at a controlled cooling rate, to avoid undesirable loss of oxygen from the composition. The cooling rate as practiced herein should not exceed 20° C. per minute. Alternatively, the cooling rate should not exceed about 10° C. per minute. In some embodiments, the cooling rate can be less than 5° C. per minute, or less than or equal to about 1° C. per minute.

In some embodiments, the flux agent can be separated from the solidified mixture of Formula I and the flux agent. The flux agent can be separated by rinsing the composition with a solvent for the flux agent, such as water for example. In some cases the flux agent can be volatilized such that the Formula I composition can be obtained substantially free of the flux agent without rinsing. In an embodiment, a small portion of the flux agent, less than 500 ppm of the composition, remains within the composition.

In a further embodiment, the composition of Formula I can be milled. In an embodiment, the energy for milling is insufficient to break the primary particles, but can deagglomerate the particles. The compositions may be characterized by their distribution of particle sizes. The particle size distribution is characterized by d10, d50, and d90, where for example, d10 is a particle diameter such that the total volume of all the particles in the sample with a diameters smaller than d10 is 10% of the entire volume of the sample. The particle diameter d90 is the diameter such that the total volume of all the particles in the sample with a diameters smaller than d90 is 90% of the entire volume of the sample. The composition obtained via the flux synthesis as described herein, when analyzed for particle size distribution, can have a d90 to d10 ratio (d90/d10) of less than 4, and even less than 3. In a surprising result, a composition as prepared according to the claimed invention can have larger average particle size and a narrower particle size distribution relative to the same composition obtained by a co-precipitation method. In another surprising development, the composition obtained according to the flux method of synthesis has substantially the same rate capability as a composition obtained by co-precipitation. This is surprising because the larger particle size of the composition obtained according to the flux synthesis would be expected to have a lower rate capability, since it should take longer for Li ions and electrons to be transported, during discharge and charge, into and out of the larger particles of the material made by flux synthesis relative to the time it takes for the transport within the smaller particles from the co-precipitation synthesis. The composition prepared by the flux synthesis therefore has a higher intrinsic rate capability than the co-precipitated material.

Further, a larger average particle size can be associated with smaller surface area of the cathode active material, which can reduce the rate of reaction with the electrolyte and provide better cycling performance. Therefore a method such as described herein, wherein particles having larger average particle size re produced as compared with a different production method, can be desirable.

A cathode can be obtained using the cathode active material of the present invention using methods known to one of ordinary skill. The materials disclosed herein are suitable for use as electro-active materials in an electrochemical cell. As a result, there is further disclosed herein an electrode for an electrochemical cell wherein the electrode is prepared from material hereof. In a preferred embodiment, the materials hereof are used to prepare a cathode in an electrochemical cell.

An electrochemical cell containing an electrode prepared from materials of the present invention is fabricated from elements that include (i) a housing; (ii) both electrodes (anode and a cathode); (iii) an electrolyte composition providing an ionically conductive pathway between the anode and the cathode wherein both electrodes are disposed in the electrolyte composition and are thus in ionically conductive contact with one another; and (iv) a porous separator between the anode and the cathode. The housing may be any suitable container to hold the components of the electrochemical cell in place.

The porous separator serves to prevent short circuiting between the anode and the cathode. The porous separator typically consists of a single-ply or multi-ply sheet of a microporous polymer. The pore size of the porous separator is sufficiently large to permit transport of ions, but small enough to prevent contact of the anode and cathode either directly or from particle penetration or dendrites which can form on the anode and cathode.

Examples of anode-active materials suitable for use to prepare an electrochemical cell as described herein, which will function to store and release lithium ions, include without limitation aluminum; platinum; tin, silicon, antimony, palladium; lithium metal; lithiated carbon; lithium alloys such as lithium-aluminum alloy, lithium-lead alloy, lithium-silicon alloys, lithium-tin alloys, lithium-antimony alloys, and the like; carbon materials such as graphite and mesocarbon microbeads (MCMB); phosphorus-containing materials such as black phosphorus, MnP4 and CoP3; metal oxides such as SnO₂, SnO and TiO₂; and lithium titanates such as Li₄Ti₅O₁₂ and LiTi₂O₄. In one embodiment, a desirable anode-active material includes lithium titanate or graphite. Suitable anode-active materials and anodes are available commercially from companies such as Hitachi Chemical (Tokyo, Japan), BTR New Energy Materials (Tianjin, China), NEI Inc. (Somerset, N.J.), and Farasis Energy Inc. (Hayward, Calif.).

An electrode for use in an electrochemical cell as disclosed herein can be prepared, for example, by mixing an effective amount of an electro-active material (e.g. about 70-96 wt %), a polymer binder (e.g. a vinyl fluoride-based copolymer such as polyvinylidene difluoride), and conductive carbon in a suitable solvent, such as N-methylpyrrolidone, to generate a paste. The paste is coated onto a metal foil, preferably aluminum or copper foil, to be used as the current collector. The paste is dried, preferably with heat, so that the active mass is bonded to the current collector, thus forming the electrode.

An electrochemical cell as disclosed herein further contains an electrolyte composition, typically a nonaqueous electrolyte composition, which is a chemical composition suitable for use to provide ionic conductivity. The electrolyte composition typically contains at least one nonaqueous solvent and at least one electrolyte salt. The electrolyte salt is an ionic salt, or mixture of salts, that is at least partially soluble in the solvent of the nonaqueous electrolyte composition and that at least partially dissociates into ions in the solvent of the nonaqueous electrolyte composition to form a conductive electrolyte composition. The conductive electrolyte composition puts the cathode and anode in ionically conductive contact with one another such that ions, in particular lithium ions, are free to move between the anode and the cathode and thereby conduct charge through the electrolyte composition between the anode and the cathode. Suitable electrolyte salts include without limitation:
lithium hexafluorophosphate,
LiPF₃(CF₂CF₃)₃,
lithium bis(trifluoromethanesulfonyl)imide,
lithium bis(perfluoroethanesulfonyl)imide,
lithium (fluorosulfonyl)(nonafluorobutanesulfonyl)imide,
lithium bis(fluorosulfonyl)imide,
lithium tetrafluoroborate,
lithium perchlorate,
lithium hexafluoroarsenate,
lithium trifluoromethanesulfonate,
lithium tris(trifluoromethanesulfonyl)methide,
lithium bis(oxalato)borate,
lithium difluoro(oxalato)borate,
Li₂13₁₂F₁₂₋ₓHₓ where x is equal to 0 to 8, and
a mixture of lithium fluoride and an anion receptor.

Any suitable electrolyte solvent, or mixtures thereof, can be used in the formation of an electrolyte composition, examples of which include without limitation ethylene carbonate, propylene carbonate, diethyl carbonate, dimethyl carbonate, ethylmethyl carbonate and dimethoxyethane. Other suitable electrolyte solvents include fluorinated solvents such as fluorinated ethers, fluorinated acyclic carboxylic acid esters, fluorinated acyclic carbonates, and fluorinated cyclic carbonates.

Fluorinated acyclic carboxylic acid esters suitable for use herein as a solvent, or in a mixture of solvents, can be a compound represented by the structure of the following formula:

R1-C(O)O—R2
wherein R1 is selected from the group consisting of CH₃, CH₂CH₃, CH₂CH₂CH₃, CH(CH₃)₂, CF₃, CF₂H, CFH₂, CF₂R³, CFHR³, and CH₂R_{f}; and
R² is independently selected from the group consisting of CH₃, CH₂CH₃, CH₂CH₂CH₃, CH(CH₃)₂, and CH₂R_{f};
R³ is a C1 to C3 alkyl group which is optionally substituted with at least one fluorine; and
R_{f} is a C1 to C3 alkyl group substituted with at least one fluorine;
provided that at least one of R¹ or R² contains at least one fluorine, and when R¹ is CF₂H, R² is not CH₃.

Examples of particular fluorine-containing carboxylic acid esters suitable for use herein as a solvent include those wherein
R¹ is CH₃CH₂— and R² is —CH₂CHF₂,
R¹ is CH₃— and R² is —CH₂CH₂CHF₂,
R¹ is CH₃CH₂— and R² is —CH₂CH₂CHF₂, or
R¹ is CHF₂CH₂CH₂— and R² is —CH₂CH₃.

In other embodiments, a co-solvent in a mixture can be a fluorine-containing carboxylic acid ester represented by the formula: R⁴—COO—R⁵, where R⁴ and R⁵ independently represent an alkyl group, the sum of carbon atoms in R⁴ and R⁵ is 2 to 7, at least two hydrogens in R⁴ and/or R⁵ are replaced by fluorines and neither R⁴ nor R⁵ contains a FCH₂ or FCH group. The presence of a monofluoroalkyl group (i.e., FCH₂ or FCH) in the carboxylic acid ester is believed to cause toxicity. Suitable co-solvents thus include without limitation CH₃CH₂—COO—CF₂H (2,2-difluoroethyl acetate), CH₃CH₂—COO—CH₂CF₂H (2,2-difluoroethyl propionate), F₂CHCH₂—COO—CH₃ (methyl 3,3-difluoropropanoate), F₂CHCH₂—COO—CH₂CH₃ (ethyl 3,3-difluoropropanoate), CH₃—COO—CH₂CH₂CF₂H (3,3-difluoropropyl acetate), CH₃CH₂—COO—CH₂CH₂CF₂H (3,3-difluoropropyl propionate), and F₂CHCH₂CH₂—COO—CH₂CH₃ (ethyl 4,4-difluorobutanoate).

In some embodiments, the co-solvent is CH₃CH₂—COO—CF₂H (2,2-difluoroethyl acetate) or CH₃CH₂—COO—CH₂CF₂H (2,2-difluoroethyl propionate).

In one embodiment, the solvent mixture of the nonaqueous electrolyte composition comprises ethylene carbonate and CH₃CH₂—COO—CF₂H (2,2-difluoroethyl acetate) or CH₃CH₂—COO—CH₂CF₂H (2,2-difluoroethyl propionate) at a weight ratio of about 30:70 and contains a phosphate additive at about 1% by weight.

Fluorinated acyclic carbonates suitable for use herein as a solvent can be a compound represented by the structure of the following formula:

R4-O—C(O)O—R5

wherein R4 and R5 are independently selected from the group consisting of CH₃, CH₂CH₃, CH₂CH₂CH₃, CH(CH₃)₂, and CH₂R_{f} where R_{f} is a C₁ to C₃ alkyl group substituted with at least one fluorine, and further wherein at least one of R4 or R5 contains at least one fluorine.

Examples of suitable fluorinated cyclic carbonates include fluoroethylene carbonate, or a compound represented by the structure of the following formula:

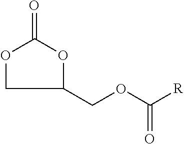

wherein R is C₁ to C₄ fluoroalkyl group.
Other suitable electrolyte solvents are described further in U.S. Provisional Patent Application Nos. 61/530,545 and 61/654,190, each of which is by this reference incorporated in its entirety as a part hereof for all purposes.

The electrochemical cells disclosed herein may be used as a power source in various electronic devices and articles such as computers, power tools, wind and solar farms, vehicles for transportation (automobiles, buses, trains, ships and airplanes) and telecommunication devices.

### EXAMPLES

The present invention is further defined in the following Examples. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various uses and conditions.

The meaning of abbreviations used is as follows: “g” means gram(s), “mg” means milligram(s), “μg” means microgram(s), “L” means liter(s), “mL” means milliliter(s), “mol” means mole(s), “mmol” means millimole(s), “M” means molar concentration, “wt %” means percent by weight, “mA” mean milliamp(s), “mAh/g” mean milliamp hour(s) per gram, “V” means volt(s), xC is a discharge current in Ampre which is numerically equal to the product of x and the nominal capacity of the battery in Ah., “SEI” means solid electrolyte interface formed on the surface of the electrode material.

### Preparation of Composite Cathodes

The cathode active material (1.04 g), prepared as described above, 0.13 g of Denka black (acetylene black, obtained from DENKA Corp., Japan), 1.08 g of polyvinylidene difluoride (PVDF) solution (12 wt % in N-methylpyrrolidone (NMP), Kureha America Inc., New York, N.Y., KFL#1120), and an additional 2.3 g of NMP were mixed first using a planetary centrifugal mixer (THINKY ARE-310, THINKY Corp., Japan) at 2000 rpm and then using a shear mixer (IKA® Works, Wilmington, N.C.) to form a uniform slurry. The slurry was coated on aluminum foil by using a doctor blade gate, and then dried in a convection oven at 100° C. for 10 to 15 min. The resulting electrode was further dried in a vacuum oven at 90° C. at −25 inches of Hg (−85 kPa) for 6 h after roll calendaring at 15 psi.

### Fabrication of Composite Cathode/Li Anode Half Cells

A cathode, prepared as described above, a Celgard® separator 2325 (Celgard, LLC. Charlotte, N.C.), a lithium foil anode (0.75 mm in thickness) and a few drops of the nonaqueous electrolyte composition of interest were sandwiched in 2032 stainless steel coin cell cans (Hohsen Corp., Japan) to form the cathode/Li anode half cells. The cycling performance and rate capability of coin cells were tested with a Maccor battery tester.

### Example 1

### Preparation of LiMn_{1.5}Ni_{0.45}Fe_{0.05}O₄ Cathode Active Material by Flux Synthesis

2.6082 g MnO₂, 0.6722 g NiO, 0.0798 g Fe₂O₃, and 0.7389 g Li₂CO₃, were mixed by Spex mixer for 1 hour. And then introduce 0.212 g LiCl (as flux agent) into the mixture. The mixture was heated up to 900° C. in air with a cooling rate of 1° C./min. The product was washed with excess deionized (DI) water to remove LiCl, and the final product is pure LiMn_{1.5}Ni_{0.45}Fe_{0.05}O₄.

### X-Ray Diffraction Patterns of LiMn_{1.5}Ni_{0.45}Fe_{0.05}O₄ Made by flux Synthesis

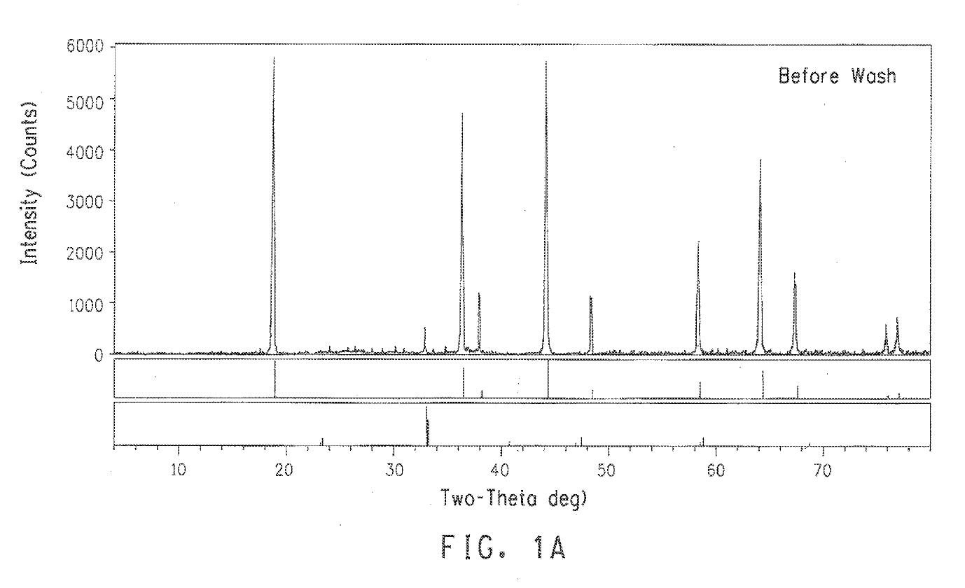

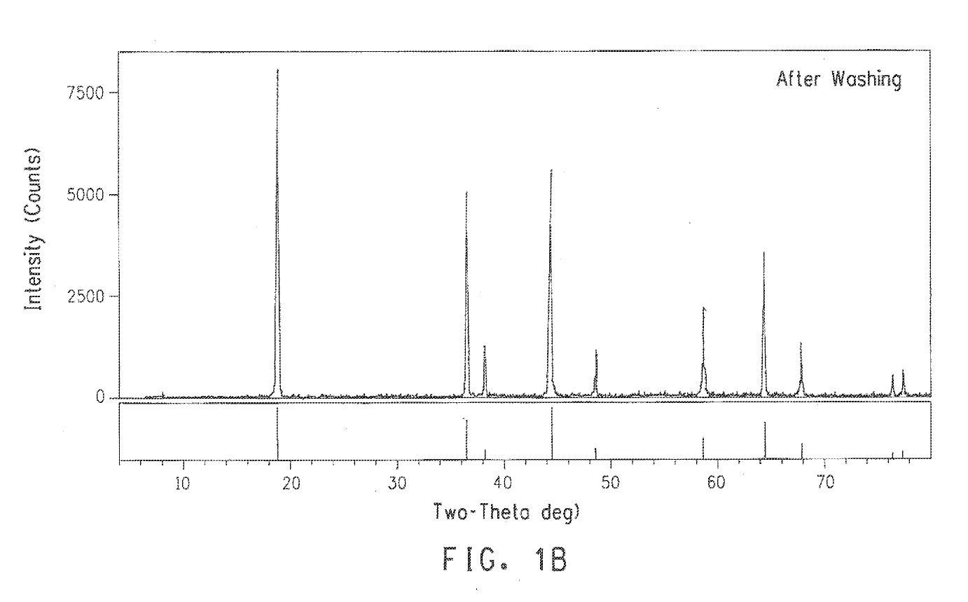

The x-ray diffraction (XRD) patterns of the LiMn_{1.5}Ni_{0.45}Fe_{0.05}O₄ (made by flux synthesis) before and after wash are shown in FIG. 1. The cubic spinel phase in both patterns is ascribed to LiMn_{1.5}Ni_{0.45}Fe_{0.05}O₄, and the LiCl hydrate was observed in the unwashed sample. Although LiCl was not observed in the pattern of the washed sample, there are still a few to a few hundred ppm LiCl that can be detected by Ion Chromatography (Model 3000, Dionex equipment), depends on how good the sample is washed.

### Example 2

### SEM of LiMn_{1.5}Ni_{0.45}Fe_{0.05}O₄ Made by Flux Synthesis

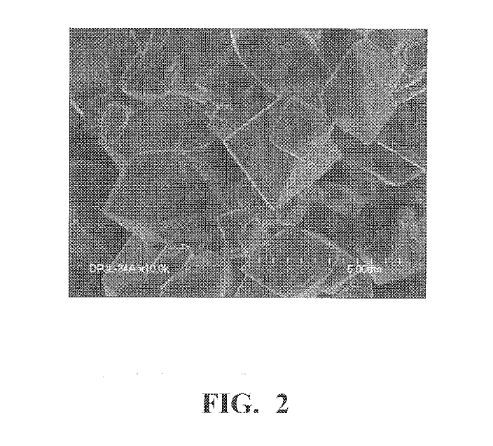

The SEM (scanning electron microscopy) picture of the LiMn_{1.5}Ni_{0.45}Fe_{0.05}O₄ made by flux synthesis is shown in FIG. 2. The octahedral morphology with clean surface is very similar to that of the LiMn_{1.5}Ni_{0.45}Fe_{0.05}O₄ made by co-precipitation synthesis (not shown here).

### Comparative Ex. 1

### Preparation of LiMn_{1.5}Ni_{0.45}Fe_{0.05}O₄ Cathode Active Material by Co-Precipitation Synthesis

The co-precipitation synthesis of Fe doped LiMn_{1.5}Ni_{0.5}O₄ was described in detail in literature (J. Phys. Chem. C 2009, 113, 15073-15079). The procedure involves the precipitation of the hydroxide precursors first from a 100 ml solution containing 7.352 g Mn(CH₃COO)₂.4H₂O, 2.240 g Ni(CH₃COO)₂.4H₂O, and 0.174 g Fe(CH₃COO)₂. The acetate solution was added into 200 ml 3 mol/L KOH solution drop by drop and produced transition metal hydroxides precipitates, which were rinsed with excess DI water to remove the impurities such as K⁺, and CH₃COO⁻. The rinsed hydroxide precipitates were oven dried and yielded 3.542 g transition metal hydroxides. The transition metal hydroxides were then mixed with 0.828 g LiOH.H₂O, and heated up to 900° C. with a cooling rate of 1° C./min. to obtain LiMn_{1.5}Ni_{0.45}Fe_{0.05}O₄.

### Example 3

### Particle Size Distribution of LiMn_{1.5}Ni_{0.45}Fe_{0.05}O₄

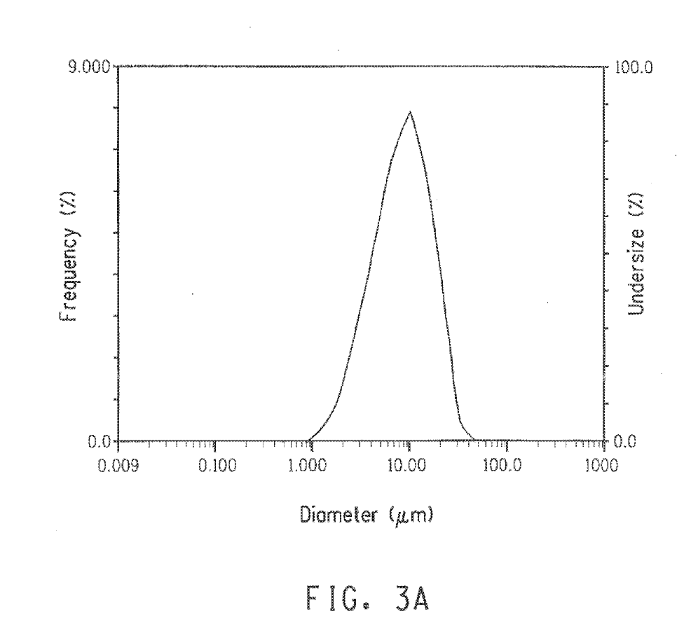

The powders from Example 1 and Comparative Example 1 were milled in isopropanol using a rolling jar mill with YZTS media 10 mm. The particle size distributions were measured using a Horiba 910 particle size analyzer. FIG. 3 compares the particle size distributions of the LiMn_{1.5}Ni_{0.46}Fe_{0.05}O₄ made by flux synthesis and by co-precipitation synthesis. Obviously, LiMn_{1.5}Ni_{0.45}Fe_{0.05}O₄ made by the flux synthesis has a narrower particle size distribution and larger average particle size, compared to the co-precipitation synthesis. The narrow particle size distribution of battery materials is preferred because of the smaller polarization difference for each particle sizes, which can potentially lead to better electrochemical performance.

### Example 4

### Charge-Discharge Curve of LiMn_{1.5}Ni_{0.46}Fe_{0.05}O₄ Made by Flux Synthesis

A LiMn_{1.5}Ni_{0.45}Fe_{0.05}O₄/Li half cell was prepared as described above using a standard electrolyte containing ethyl carbonate (EC)/ethyl methyl carbonate (EMC) in a volume ratio of 30:70 and 1 M LiPF₆ (Novolyte, Cleveland, Ohio). This half cell was cycled between 3.5 and 4.95 V at 20 mA/g and 25° C.

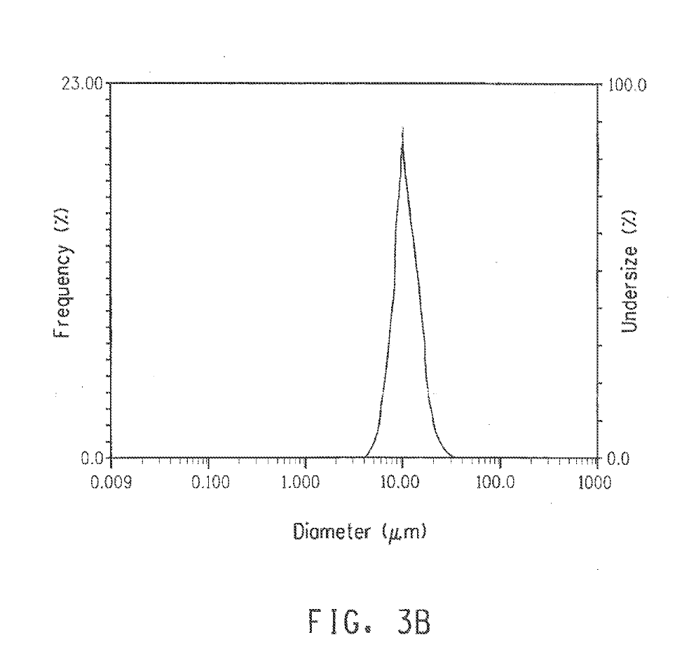

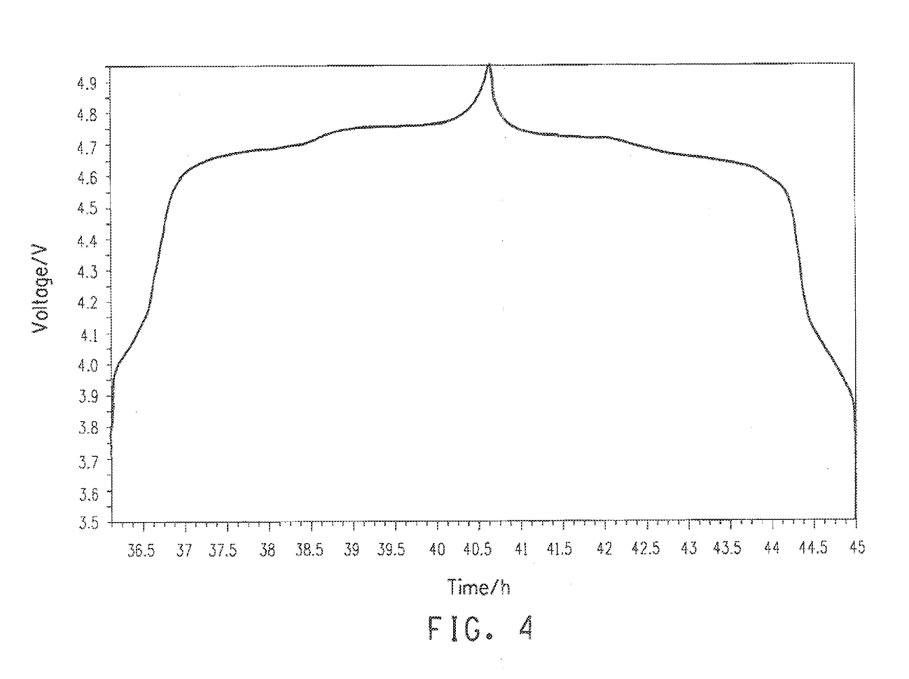

The typical charge-discharge curve is shown in FIG. 4. The voltage plateau at ˜4.7 V is observed, and the discharge capacity was calculated to be ˜135 mAh/g.

### Example 5

### Cycling Performance of LiMn_{1.5}Ni_{0.45}Fe_{0.05}O₄

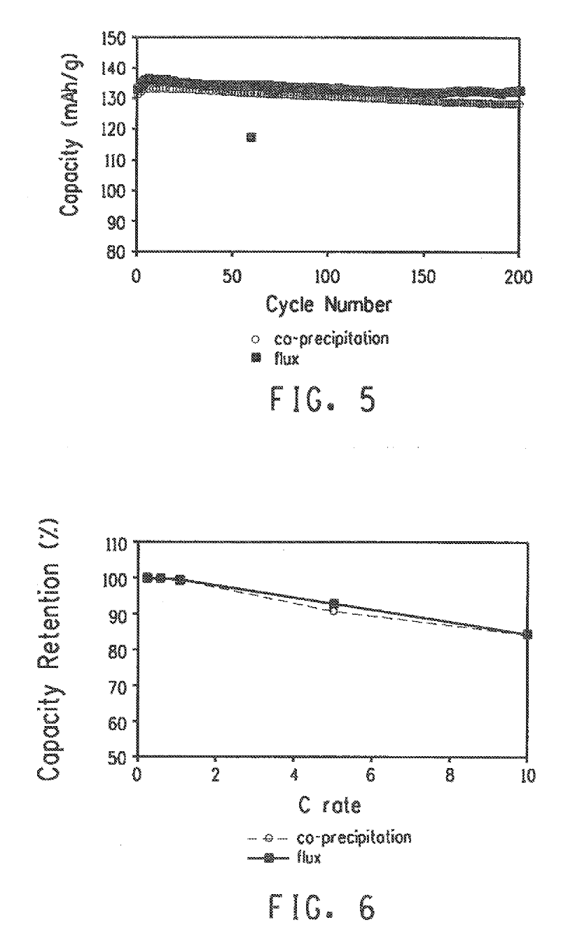

FIG. 5 compares the room temperature cycling performances of the LiMn_{1.5}Ni_{0.46}Fe_{0.05}O₄ made by flux synthesis and by co-precipitation synthesis. LiMn_{1.5}Ni_{0.46}Fe_{0.05}O₄/Li half cells were cycled between 3.5 and 4.95 V at 20 mA/g LiMn_{1.5}Ni_{0.46}Fe_{0.05}O₄ made by co-precipitation synthesis delivered 96% capacity retention in 200 cycles, while LiMn_{1.5}Ni_{0.46}Fe_{0.05}O₄ made by flux synthesis delivered 98%.

### Example 6

### Rate Capability of LiMn_{1.6}Ni_{0.45}Fe_{0.05}O₄

The discharge capacities of LiMn_{1.5}Ni_{0.45}Fe_{0.05}O₄ cathodes at different C rates are normalized to the discharge capacity at 0.2 C, and are plotted against C rate to demonstrate the rate capability. FIG. 6 compares the rate capability of the LiMn_{1.5}Ni_{0.45}Fe_{0.05}O₄ made by flux synthesis and by co-precipitation synthesis. Although at different C rates, LiMn_{1.5}Ni_{0.45}Fe_{0.05}O₄ made by flux synthesis has very similar capacity retention, compared to LiMn_{1.5}Ni_{0.45}Fe_{0.05}O₄ made by co-precipitation synthesis, LiMn_{1.5}Ni_{0.45}Fe_{0.05}O₄ made by flux synthesis has better rate capability, considering that it has larger average particle size.

What is claimed is:

1. A method for preparing a cathode active composition of the formula
Li_{z}Mn_{2-x-y}AₓQ_{y}O_{4-d} (Formula I),
wherein the method comprises the steps of:
(a) combining
(i) the salts and/or oxides of the metals Li, Mn, A, and Q with
(ii) a flux agent having a melting temperature in the range of from about 200° C. to about 850° C.,
to form a mixture of same;
(b) heating the mixture of step (a) to a temperature of at least the melting temperature of the flux agent, to obtain a molten flux composition comprising the salts and/or oxides of the metals Li, Mn, A and Q, and flux agent; and
(c) cooling the molten flux composition of step (b) at a cooling rate of less than about 20° C./minute for at least until such time that said molten flux composition solidifies to form a solid composition,
wherein:
A is at least one metal selected from the group consisting of Ni, Co, Fe, Cr;
Q is at least one metal selected from the group consisting of Li, Al, Cr, Ni, Fe, Ga, Zn, Ca, Co, Nb, Mo, Ti, Zr, Mg, V and Cu;
x is any value in the range from 0.35 to less than 0.6;
y is any value in the range of greater than 0.005 to about 0.12;
d is any value in the range of from 0 to about 0.3; and
z is any value in the range of greater than 0.9 to about 1.1.

2. The method of claim 1 further comprising the step:
(d) separating the flux agent from the solid composition of step (c) to obtain particles of substantially the composition of Formula I.

3. The method of claim 1, characterized in that the particles of Formula I have a particle size distribution having a ratio d90/d10 of less than about 4.

4. The method of claim 3 wherein the ratio d90/d10 is less than about 3.

5. A composition of Formula I prepared by the method of claim 1.

6. A cathode comprising the composition of claim 5.

7. A cell comprising the cathode of claim 6.

8. The composition of claim 5 wherein A comprises Ni.

9. The composition of claim 8 wherein Q comprises Fe.

10. The method of wherein the flux agent comprises lithium chloride and/or lithium sulfate.

11. The cell of claim 6 wherein the electrolyte comprises a partially fluorinated carbonate and/or a partially fluorinated linear ester.

12. A composition substantially of Formula I, prepared by the method of claim 2, wherein after separating the majority of flux agent from the composition, the composition still retains a small portion of the flux agent.
